(19) United States
(12) Patent Application Publication
(10) Pub. No.: US 2002/0122468 A1
(43) Pub. Date: Sep. 5, 2002

(54) Quasi orthogonal hybrid walsh-PN codes for CDMA application in HF modems

(75) Inventor: Madjid Adam Belkerdid, Casselberry, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Terion, Inc., Melbourne, FL (US)

(21) Appl. No.: 09/760,389

(22) Filed: Jan. 12, 2001

(51) Int. Cl. H04K 1/00; H04L 27/30

(52) U.S. Cl. 375/146; 370/209

(57) ABSTRACT

HF modems operate at the HF licensed frequency bands ranging from 3 to 25 MHz. This invention deals with a Quasi CDMA application of a low bit rate modem operating at a rate of 125 bps. This low rate modem has been operational for some time now, and is based on the MIL-STD 188-110A waveforms.

The modulator of the low bit rate modem processes the information data at the mobile transmitter before it sends the HF angle modulated carrier to one of the remote base station (RBS) sites, where the information is processed and demodulated and forwarded to the Network Operation Center (NOC).

The modulated waveform generated by the HF transmitter consists of a preamble, data spreading by Walsh functions, Walsh scrambling by a Pseudo-Noise (PN) sequence, channel symbol formation, and the Direct Digital synthesizer implementing an 8 Phase Shift Keying (8PSK) to 8-Ary Continuous Phase Frequency Shift Keying (CPFSK) signaling converter. The HF modem transmits a 4 second HF burst at the allowed HF frequency. This burst is made up of four 32 channel symbol frames for the preamble and 5 repeated constant duration HF blocks.

### BACKGROUND OF THE INVENTION

The present invention relates generally to Direct Sequence Spread Spectrum (DSSS) communication systems, and more specifically to Code Division Multiple Access (CDMA) as used with High Frequency (HF) radio frequency modems in a two-way communications network.

In a spread spectrum system, the bandwidth of the transmitted signal is greater than the minimum Radio Frequency (RF) bandwidth required to transmit the information signal. This spectral spreading is typically accomplished by means of a spreading signal, often called a code signal. The ratio of the transmitted bandwidth to the information bandwidth is referred to as processing gain. The processing gain is a true RF signal to noise ratio improvement, and hence spread spectrum systems usually operate at negative signal to noise ratio because of the processing gain. In a so-called Direct Sequence Spread Spectrum (DSSS) system, the code signal usually can be selected from a number of coded sequences, such as pseudo-noise (PN) sequences, maximum length sequences (m-sequences), Barker codes, Walsh codes, and Gold codes. At the receiver, the original signal is recovered by the correlation of the received spread signal with a synchronized replica of the spreading code signal.

Codes with good autocorrelation properties such as m-sequences, Barker codes, and Walsh codes are normally used in a single user environment. Gold codes, Walsh codes, and a combination of Walsh and m-sequence codes are normally used in a multi-user Code Division Multiple Access (CDMA) environment.

An example of spreading with Barker codes is the IEEE 802.11 standard for Wireless Local Area Network (WLAN) where DSSS modulation is used at the physical layer. At low bit rates, an 11-bit Barker Sequence is used to spread each data bit before it is transmitted. All 802.11 compliant systems utilize the same spreading code, and therefore, a set of codes is not typically needed.

8-bit Walsh functions also are used as spreading waveforms in what is referred to as M-ary Orthogonal Keying (MOK) and M-ary Bi-Orthogonal Keying (MBOK) in the IEEE 802.11 standards. In this case, three data bits are used to select one of eight Walsh functions to achieve the required processing gain.

Maximum length sequences (m-sequences) are also used in DSSS when CDMA is not needed. They are easily generated by linear shift registers and exclusive OR gates, as governed by the selected primitive polynomial. The order of the polynomial sets the period of the sequence. It is possible to conceptualize multiple access systems using such codes, since more than one primitive polynomial exists. These sequences have good correlation properties that are very important for code alignment at the receiver. Unfortunately, the primitive polynomial codes have poor crosscorrelation properties, which make them typically not good enough for use in a CDMA environment.

Gold Codes are generated by modulo-two addition of two m-sequences of the same order. These two code pairs, called preferred pairs, have to be chosen to satisfy a so-called Gold preferred pair criterion. Gold codes do have very good crosscorrelation properties that make them the spread codes of choice in a CDMA environment. For example, the Global Positioning System (GPS) uses 1023 chip Gold code sequences to permit up to twenty-four satellites in a semi-geo-synchronous orbit to transmit on the same radio carrier frequency. Each satellite uses two tenth-order primitive polynomials to form the preferred pairs. The initial conditions applied to the two 10-bit shift registers assign a unique code for each satellite.

The TIA IS-95 standard for digital cellular telephone communication is another example of a CDMA communication system. This system uses Walsh functions and m-sequences for spreading in the forward channel. In particular, input user data is first spread by a 64-ary orthogonal Walsh function. The resulting Walsh spread user data is then spread by a PN sequence unique to each base station. Both the Walsh codes and the PN codes therefore perform spreading operations in this system.

### SUMMARY OF THE INVENTION

Sometimes, even with the use of spread spectrum techniques, an existing deployed system reaches its designed capacity limits. This can come quite soon for a system that was not originally designed as a Code Division Multiple Access (CDMA) system. In the past, adding capacity to such systems typically required the replacement of the radio equipment in the existing field units and base stations to accommodate additional codes.

There exists a need for a way to expand capacity of such systems without replacing the existing deployed field units and without degrading the performance of the system as a whole.

The present invention provides a solution to this problem by devising one or more sets of new pseudorandom PN codes that are as orthogonal as possible to the originally selected set of PN codes. The codes are selected by an exhaustive search of codes having the same polynomial order as the original set of codes. An exhaustive search is performed to select the sequence or sequences that possess the best cross correlation properties with respect to each other and to each of the original codes.

For example, the search criteria may be based on selecting a maximum correlation peak with respect to side lobe ratios and a minimum correlation peak with respect to side lobe ratios.

The signal encoded in this manner may have additional properties such as being further modulated by Walsh codes.

The technique may be used to achieve orthogonality such that code diversity is provided for during a single acquisition phase. This hybrid orthogonal code approach therefore not only provides download compatibility with existing coded waveforms but also allows for providing a Code Division Multiple Access functionality since the scrambled data yields low cross correlation values.

In a preferred embodiment, data bits may be encoded as symbols such as from 4 data bits encoded selected from among thirty-two Walsh symbols. A 16^{th} or pseudo-random sequence generator can then be used to generate 65,535 Pseudo-Noise tribit symbols per period. Three 32 bit PN symbols may be selected from such generated sequences to be transmitted prior to the transmission of the data encoded PN scrambled Walsh signal. The preamble and data encoded PN randomized Walsh function is then transmitted on a radio frequency signal with a carrier frequency in the range of from approximately 3 to 25 MegaHertz (MHz). In accord with the invention, a second modem operating at the same RF carrier frequency as the first modem with the preamble PN codes set to be quasi-orthogonal to a preamble sequence of the first modem and with Walsh randomizing PN codes being quasi-orthogonal to each other.

The quasi-orthogonal CDMA scheme provides acceptable performance at a range of signal to noise ratio levels allowing for discrimination between two signals received at the same receiver site or for proper discrimination of a single signal from another signal antenna for reception at a different site.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a two-way messaging system where an HF modem operating in accordance with the invention may be used.

FIG. 2 denotes fixed HF Remote Base Station locations.

FIG. 3 depicts an HF modem transmitter which is used in the prior art.

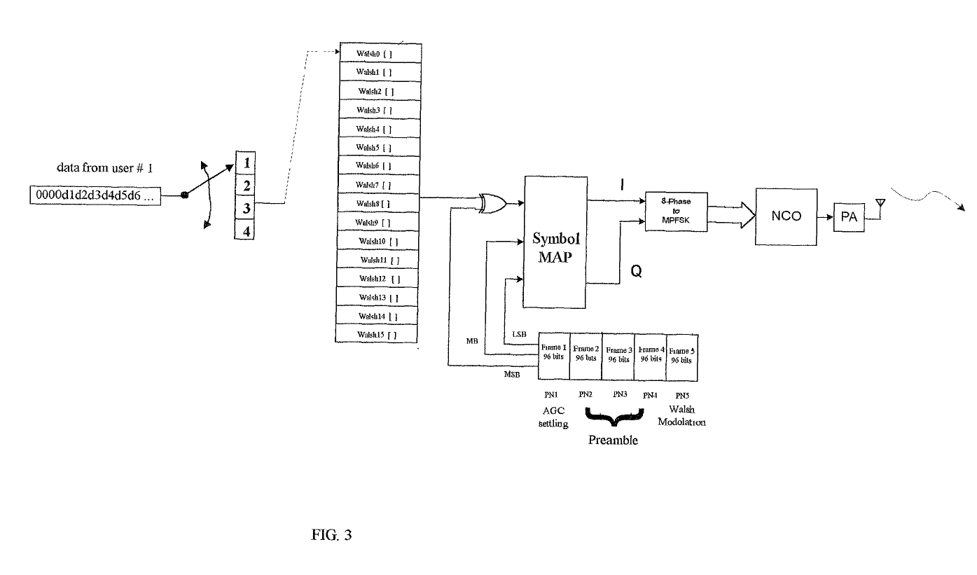

FIG. 4 depicts a linear shift register implementation of a 16^{th} order polynomial used to generate PN codes.

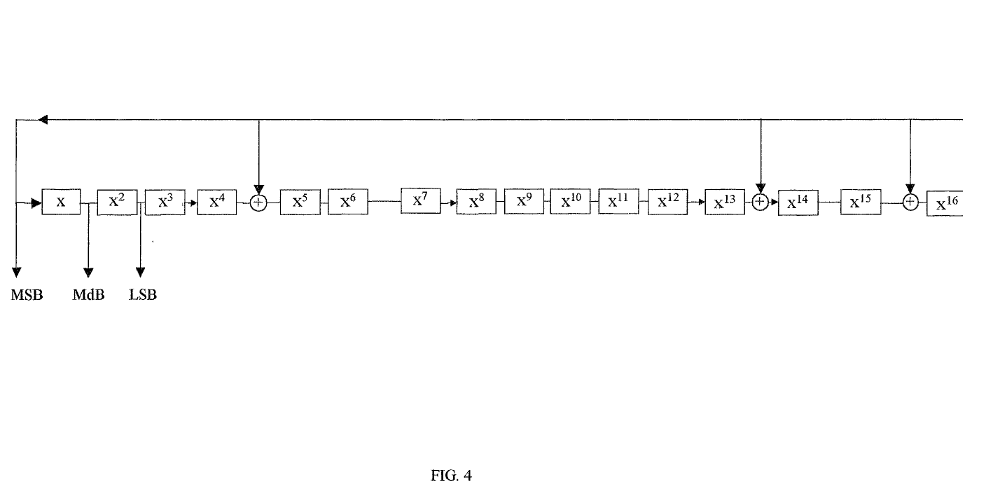

FIG. 5 depicts a characteristic of an HF burst.

FIG. 6 is a block diagram of a transmitter designed in accordance with the invention.

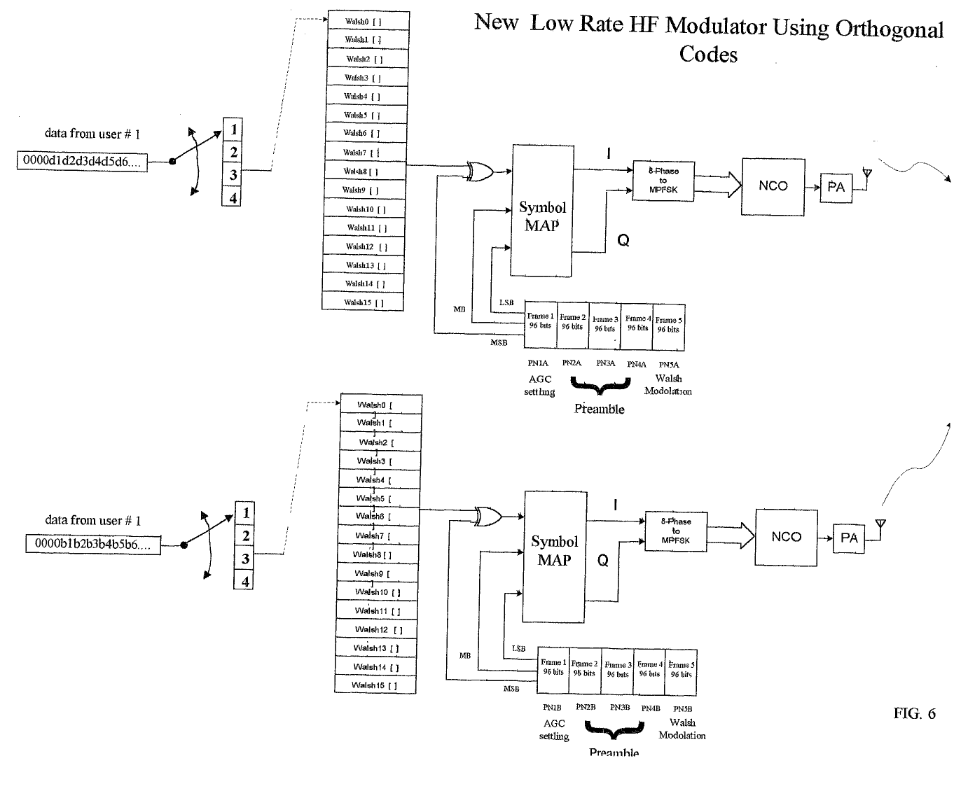

FIG. 7 is a block diagram of a receiver designed in accordance with the invention.

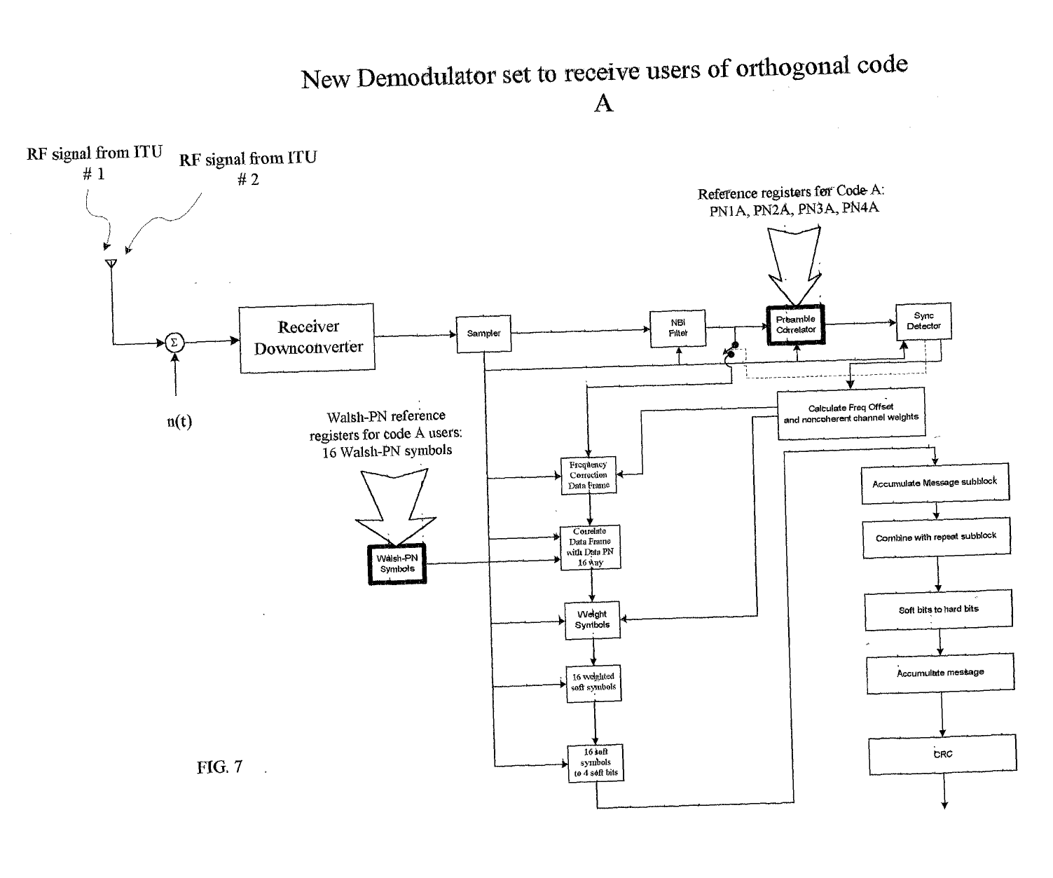

FIG. 8 depicts message error rate performance of the invention in a noise free environment.

FIG. 9 depicts message error rate performance of the invention in a noisy environment, with equal signal power level.

FIG. 10 depicts message error rate performance of the invention in a noisy environment, with unequal signal power level.

### DETAILED DESCRIPTION OF THE INVENTION

The mobile unit 1 includes the transmitter operating in the High Frequency (HF) band ranging from 3 to 30 MHZ. The transmitted signals are to refract from the Ionosphere and be received by HF receivers located in eight stationary, remote, and strategically located base stations 2.

The duplex network uses an Ionospheric link 10, a satellite communication link 11, an FM band link 12, and a frame relay link 13.

The invention uses sixteen modified Walsh functions to spread the data, and a PN sequence to scramble and randomize the Walsh spread user data.

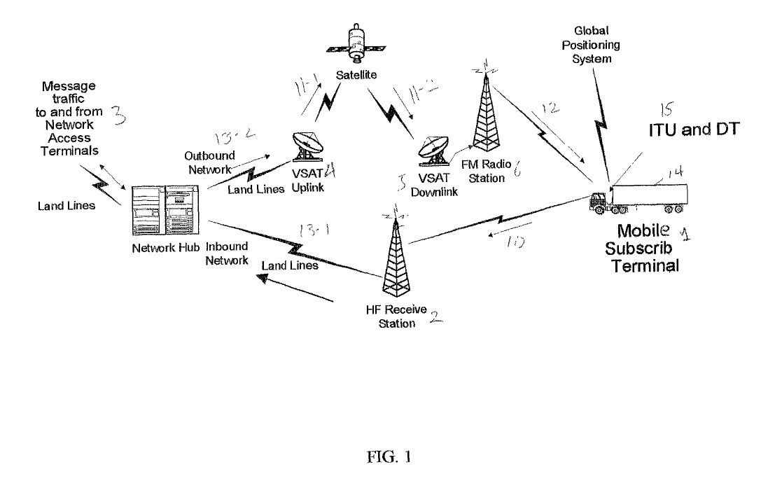

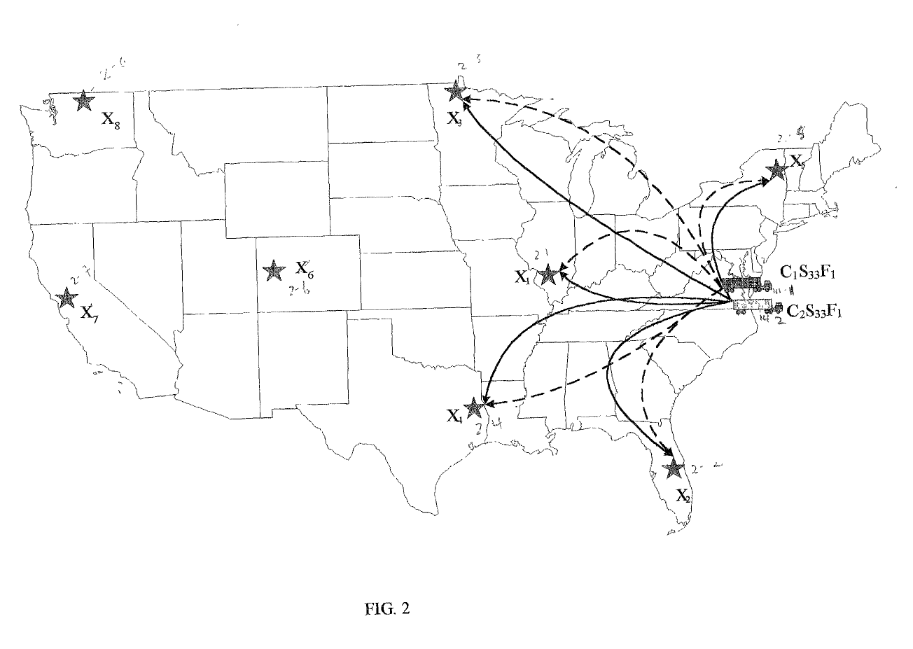

Now referring to FIG. 1, the invention is used in an HF modem in a large two-way messaging system 30. This two-way-messaging system 30 is a multi-channel, multi-platform, and multi-technology communication system. The Network Operation Center (NOC) 3 is the reference origin of the two-way communications coordinate system. A message originating from a customer terminal is sent from the NOC 3 via a satcom uplink 4 and a satcom downlink 5, linked to FM base stations 6 scattered around the country. The FM base station 6 decodes the information and then rebroadcasts it on its RDBS sub-carrier. The mobile unit 1 on a truck 14 receives the RDBS sub-carrier. The information received could be an email message Acknowledgement, Remote Initiated Frequencies (RIFs), System Initiated Frequencies (SIFs), or query. The mobile unit 1 also receives GPS data. The mobile unit 1 sends information using an HF transmitter. The HF signal is refracted by the Ionosphere and is received by one or more of the eight-fixed location Receive Base Stations (RBS) 2. In FIG. 2, RBS stations 2 are denoted by stars. The signal is demodulated at a RBS site 2 and shipped to the NOC 3 via frame relay 13. The HF modem is housed in two disjointed subsystems. The modulator component is housed in the Intelligent Transceiver Unit (ITU) 15 in the mobile vehicle 14. The demodulation component is located at the RBS sites 2. The continental United States may be divided into forty-four 5 degree by 5 degree HF sectors. These sectors are centered around a fixed ITU called “pingers”. These pingers periodically transmit a one block HF message over the HF frequency bands. The RBS sites 2 receive the pinger signals and then relay the results to the NOC 3, which determines which HF frequencies are propagating. RIFs are then issued to various sectors.

The invention deals with the HF modulator in the mobile ITU 15 and the HF receiver at one of the RBS stations 2. The present modem uses one carrier frequency at a time. This makes the number of licensed HF frequencies a limiting factor on the system capacity, which translates to a limited number of users. For clarity, the designations bits, chips, and slivers are adopted for data, Walsh, and PN symbols, respectively.

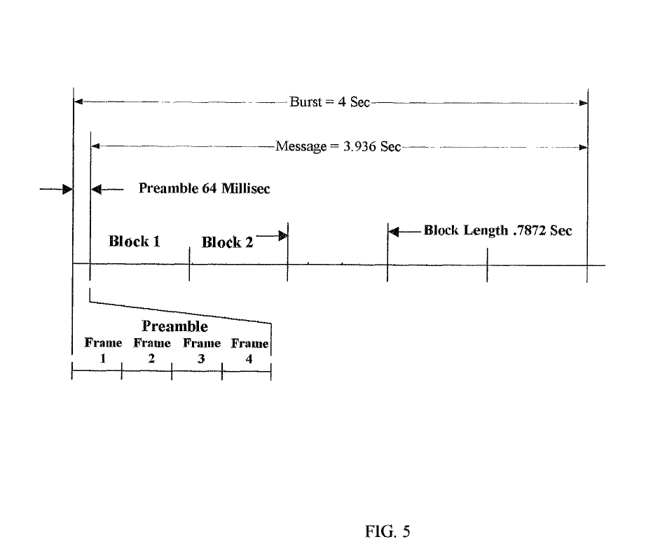

The modulated waveform generated by the transmitting ITU 15 consists of a preamble, data spreading by Walsh functions, Walsh scrambling by a Pseudo-Noise (PN) sequence, channel symbol formation, and the Direct Digital synthesizer implementing an 8 Phase Shift Keying (8PSK) to 8-Ary Continuous Phase Frequency Shift Keying (CPFSK) signaling converter. The HF modem transmits a four second HF burst at the allowed HF frequency. As illustrated in FIG. 5, the burst is made up of four 32 channel symbol frames for the preamble and 5 repeated constant duration HF blocks.

The Preamble of the low bit rate modem is made up of four data frames. These frames are made up of a set of four 32 tri-bit symbol PN sequences. The first PN sequence is used for AGC settling and is not used for correlation purposes at the receiver. These PN sequences are generated from a pseudo-random pulse generator of the residue type based on a 16^{th} order primitive polynomial given by:

g(x)=1+x⁴+x¹³+x¹⁵+x¹⁶

The MSB, MdB, and LSB form the tri-bit symbols. A symbol, 3 bit equivalent to decimal number, is generated with each clock pulse. A set of four initial conditions is used to generate the four preamble sequences. These are given below:

ICs=110011100100011

PN1=7 6 4 1 3 6 5 2 5 3 6 5 2 4 0 0 0 0 1 2 4 0 1 2 5 3 7 7 6 5 3 7

IC's=0011010000110111

PN2=6 4 1 2 4 0 0 0 0 0 1 2 4 0 0 1 3 7 7 6 5 2 5 2 4 1 2 5 3 6 4 0

IC's=1000101010000001

PN3=3 7 7 6 4 1 2 4 0 0 0 0 1 2 5 3 6 5 3 7 6 4 1 3 6 5 3 6 4 0 0 0

IC's=0110100111110011

PN4=6 5 2 4 0 0 0 1 2 5 3 6 5 3 6 4 1 2 4 0 0 1 2 5 3 7 7 6 5 3 7 6

The preamble signal is followed by a spread and scrambled data signal. One out of sixteen modified 32 bit Walsh functions is selected by four input data bit yielding a processing gain of 32/8=4. The resulting Walsh function is scrambled by 32 tri-bit PN sequence chosen from a long pseudo-random sequence of (2¹⁶−1) bits. The Walsh functions are the rows of a Hadamard matrix defined as:

$${H}_{1} = [ 0 ] {H}_{2 n} = [ \begin{matrix}{H}_{n} & {H}_{n} \\ {H}_{n} & {\overline{H}}_{n}\end{matrix} ]$$

where the bar over Hₙ denotes the logic complement. With this recursive formula a set of 2,4,8, and 16 chip Walsh functions are represented by the rows of H₂ₙ. The set of sixteen 32 chip modified Walsh functions is obtained by repeating the 16 chips for each function as shown by:

H16=[H16 H16]

For example the modified Walsh function number 8 is given by:

W₈=[0 1 0 1 0 0 1 0 1 1 0 1 0 0 1 0 1 1 0 1 0 0 1 0 1 1 0 1 0 0 1]

The Walsh scrambling sequence, PN0, is generated from the same circuit as the preamble PN sequences using a new set of Initial conditions as shown below:

IC's=0010110111111000

PN5=0 0 1 3 6 4 1 2 5 3 6 4 0 0 1 2 4 1 3 6 4 0 1 3 6 4 0 0 0 0 1 3 7

The first chip of each Walsh function operates exclusive-OR on the MSB of the first tri-bit symbol of PN5 and so on, to randomize the signal.

The signal is then fed to an 8-Ary Phase shift Keying (8PSK) modulator, implemented with a Direct Digital Synthesizer for HF transmission.

Each ITU 15 receives a RIF in the sector it happened to be in and begins transmission using one of the licensed HF frequency coded by the RIF. Presently the RIFS are distinct among the different HF sectors. The invention calls for the use of a new set of five PN codes. The first four being orthogonal to the original PN codes used for the preamble, and the 5^{th} PN code is chosen to yield a Walsh-PN spread set orthogonal to the original Walsh-PN spread code. A computer algorithm is developed to search for the best possible codes in terms of autocorrelation functions as well as crosscorrelation functions.

With the use of orthogonal codes, two or more ITUs 15 in the same sector can use the same frequency at the same time, in a quasi CDMA mode. The orthogonal ITU uses a set of four PN sequences chosen such that they possess good crosscorrelation properties with respect to each other and to each of the original 4 PN generator (the 4 PN generator is used for AGC settling). A fifth orthogonal PN generator is similarly used to scramble the Walsh functions in the orthogonal ITU 15. Unlike a classical CDMA environment, the HF environment does not require signal power level control.

An algorithm is used to find optimum orthogonal PN codes used in the preamble as well as a quasi-orthogonal code for the Walsh-PN sequence. The algorithm for the four preamble codes stated with the 16^{th} order PN generator with the appropriate initial conditions. The entire period of 2¹⁶−1=65,536−1=65,535 slivers is searched for the best 32 tri-bit sequence. The search criterion is based on maximum autocorrelation peak to side lobe ratios, and minimum crosscorrelation peak to sidelobe ratios. The algorithm is performed with a one sliver delay resolution between searches. For the Walsh-PN sequence search, the 32 tri-bit PN symbols are first chosen. Then crosscorrelation tests are performed on the resulting Walsh-PN sequence.

### Code Search Algorithm Sample Results

Codes from Prior Art:

Preamble:

PN1=[7 6 4 1 3 6 5 2 5 3 6 5 2 4 0 0 0 0 1 2 4 0 1 2 5 3 7 7 6 5 3 7];

PN2=[6 4 1 2 4 0 0 0 0 0 1 2 4 0 0 1 3 7 7 6 5 2 5 2 4 1 2 5 3 6 4 0];

PN3=[3 7 7 6 4 1 2 4 0 0 0 0 1 2 5 3 6 5 3 7 6 4 1 3 6 5 3 6 4 0 0 0];

PN4=[6 5 2 4 0 0 0 1 2 5 3 6 5 3 6 4 1 2 4 0 0 1 2 5 3 7 7 6 5 3 7 6];

Walsh Scrambling Sequence:

PN0=[0 0 1 3 6 4 1 2 5 3 6 4 0 0 1 2 4 1 3 6 4 0 1 3 6 4 0 0 0 1 3 7];

Resulting Walsh-PN Set:

WPNA0=[7 4 3 0 5 1 5 0 2 2 1 1 5 7 4 3 5 0 2 6 2 1 6 2 0 0 5 0 5 2 6 6];

WPNA1=[7 0 3 4 5 5 5 4 2 6 1 5 5 3 4 7 5 4 2 2 2 5 6 6 0 4 5 4 5 6 6 2];

WPNA2=[7 4 7 4 5 1 1 4 2 2 5 5 5 7 0 7 5 0 6 2 2 1 2 6 0 0 1 4 5 2 2 2];

WPNA3=[7 0 7 0 5 5 1 0 2 6 5 1 5 3 0 3 5 4 6 6 2 5 2 2 0 4 1 0 5 6 2 6];

WPNA4=[7 4 3 0 1 5 1 4 2 2 1 1 1 3 0 7 5 0 2 6 6 5 2 6 0 0 5 0 1 6 2 2];

WPNA5=[7 0 3 4 1 1 1 0 2 6 1 5 1 7 0 3 5 4 2 2 6 1 2 2 0 4 5 4 1 2 2 6];

WPNA6=[7 4 7 4 1 5 5 0 2 2 5 5 1 3 4 3 5 0 6 2 6 5 6 2 0 0 1 4 1 6 6 6];

WPNA7=[7 0 7 0 1 1 5 4 2 6 5 1 1 7 4 7 5 4 6 6 6 1 6 6 0 4 1 0 1 2 6 2];

WPNA8=[7 4 3 0 5 1 5 0 6 6 5 5 1 3 0 7 5 0 2 6 2 1 6 2 4 4 1 4 1 6 2 2];

WPNA9=[7 0 3 4 5 5 5 4 6 2 5 1 1 7 0 3 5 4 2 2 2 5 6 6 4 0 1 0 1 2 2 6];

WPNA10=[7 4 7 4 5 1 1 4 6 6 1 1 1 3 4 3 5 0 6 2 2 1 2 6 4 4 5 0 1 6 6 6];

WPNA11=[7 0 7 0 5 5 1 0 6 2 1 5 1 7 4 7 5 4 6 6 2 5 2 2 4 0 5 4 1 2 6 2];

WPNA12=[7 4 3 0 1 5 1 4 6 6 5 5 5 7 4 3 5 0 2 6 6 5 2 6 4 4 1 4 5 2 6 6];

WPNA13=[7 4 3 0 1 5 1 4 6 6 5 5 5 7 4 3 5 0 2 6 6 5 2 6 4 4 1 4 5 2 6 6];

WPNA14=[7 4 7 4 1 5 5 0 6 6 1 1 5 7 0 7 5 0 6 2 6 5 6 2 4 4 5 0 5 2 2 2];

WPNA15=[7 0 7 0 1 1 5 4 6 2 1 5 5 3 0 3 5 4 6 6 6 1 6 6 4 0 5 4 5 6 2 6];

Orthogonal Code Set #1:

Preamble:

PNO1=[0 2 4 3 3 6 4 5 7 6 7 0 5 5 4 3 5 4 3 7 0 7 6 2 6 2 4 6 7 2 4 7];

PNO2=[5 5 7 0 7 3 3 3 7 3 3 1 4 2 3 7 0 2 7 7 3 5 1 0 1 4 0 5 0 0 0 0];

PNO3=[7 5 1 4 5 4 2 0 6 1 4 7 5 0 1 0 3 0 3 1 3 5 1 2 5 0 1 7 1 4 6 0];

PNO4=[2 3 3 4 2 5 2 5 4 5 7 3 1 0 1 6 4 1 1 2 1 4 1 5 4 2 7 4 5 1 6 4];

Walsh Scrambling Sequence:

PNO0=[7 4 3 0 5 1 5 0 2 2 1 1 5 7 4 3 5 0 2 6 2 1 6 2 0 0 5 0 5 2 6 6];

Resulting Walsh-PN Set:

wpn0=[0 0 1 3 6 4 1 2 5 3 6 4 0 0 1 2 4 1 3 6 4 0 1 3 6 4 0 0 0 1 3 7];

wpn1=[0 4 1 7 6 0 1 6 5 7 6 0 0 4 1 6 4 5 3 2 4 4 1 7 6 0 0 4 0 5 3 3];

wpn2=[0 0 5 7 6 4 5 6 5 3 2 0 0 0 5 6 4 1 7 2 4 0 5 7 6 4 4 4 0 1 7 3];

wpn3=[0 4 5 3 6 0 5 2 5 7 2 4 0 4 5 2 4 5 7 6 4 4 5 3 6 0 4 0 0 5 7 7];

wpn4=[0 0 1 3 2 0 5 6 5 3 6 4 4 4 5 6 4 1 3 6 0 4 5 7 6 4 0 0 4 5 7 3];

wpn5=[0 4 1 7 2 4 5 2 5 7 6 0 4 0 5 2 4 5 3 2 0 0 5 3 6 0 0 4 4 1 7 7];

wpn6=[0 0 5 7 2 0 1 2 5 3 2 0 4 4 1 2 4 1 7 2 0 4 1 3 6 4 4 4 4 5 3 7];

wpn7=[0 4 5 3 2 4 1 6 5 7 2 4 4 0 1 6 4 5 7 6 0 0 1 7 6 0 4 0 4 1 3 3];

wpn8=[0 0 1 3 6 4 1 2 1 7 2 0 4 4 5 6 4 1 3 6 4 0 1 3 2 0 4 4 4 5 7 3];

wpn9=[0 4 1 7 6 0 1 6 1 3 2 4 4 0 5 2 4 5 3 2 4 4 1 7 2 4 4 0 4 1 7 7];

wpn10=[0 0 5 7 6 4 5 6 1 7 6 4 4 4 1 2 4 1 7 2 4 0 5 7 2 0 0 0 4 5 3 7];

wpn11=[0 4 5 3 6 0 5 2 1 3 6 0 4 0 1 6 4 5 7 6 4 4 5 3 2 4 0 4 4 1 3 3];

wpn12=[0 0 1 3 2 0 5 6 1 7 2 0 0 0 1 2 4 1 3 6 0 4 5 7 2 0 4 4 0 1 3 7];

wpn13=[0 4 1 7 2 4 5 2 1 3 2 4 0 4 1 6 4 5 3 2 0 0 5 3 2 4 4 0 0 5 3 3];

wpn14=[0 0 5 7 2 0 1 2 1 7 6 4 0 0 5 6 4 1 7 2 0 4 1 3 2 0 0 0 0 1 7 3];

wpn15=[0 4 5 3 2 4 1 6 1 3 6 0 0 4 5 2 4 5 7 6 0 0 1 7 2 4 0 4 0 5 7 7];

Orthogonal Code Set #2:

Preamble:

PNWO1=[3 7 6 4 1 3 7 7 6 4 0 0 1 2 4 0 0 0 1 2 5 3 6 4 0 0 0 0 1 3 6 5];

PNWO1=[4 0 0 0 0 0 0 1 3 7 7 7 6 4 0 0 0 0 0 1 2 5 3 7 7 7 7 7 6 5 2 5];

PNWO1=[7 6 4 0 0 0 1 3 7 7 7 6 5 3 6 4 0 0 1 2 5 3 7 7 6 5 3 7 7 7 7 6];

PNWO1=[24 0 1 2 5 3 7 7 7 6 5 2 5 2 4 1 2 5 2 5 2 5 2 5 2 4 0 1 2 5 2];

Walsh Scrambling Sequence:

PNWO1=[6 5 2 5 3 7 6 4 0 0 0 1 2 4 0 0 1 3 7 7 7 7 6 4 1 3 7 7 7 7 7 7];

IT is not presently possible without potentially destructive collisions to have two mobile units each located in the same HF sector and each transmitting over the same frequency at the same time. In FIG. 2, each truck 14 is now using a code orthogonal to each other and each ITU 15 is denoted by C₁SⱼFₖ. The subscripts i, j, and k denote the truck ID, sector ID and frequency respectively. In the example depicted in FIG. 2, the ITUs 15 are labeled as C₁S₃₃F₁, and C₂S₃₃F₁, The two trucks 14 are in sector thirty-three and transmitting at the same frequency, the first truck 14-1 using code 1 and the second truck 14-2 using code 2.

The signal received at each of the eight RBS 2 is denoted by S₁Pⱼ, where i is the signal origination index and j is the RBS index. For example, S₁P₃ indicates a signal transmitted by the first ITU 15 and received by the third RBS 2. Each RBS 2 can receive either signal or both signals depending on the signal level difference between them and signal to noise ratio. Having both orthogonal ITU's 15 transmitting at the same frequency at the same time is better than using a single code and a single ITU. Unlike a true CDMA system, this system does not have to have equal power level at one of the RBS's. It is not necessary that both orthogonal signals are received with equal power.

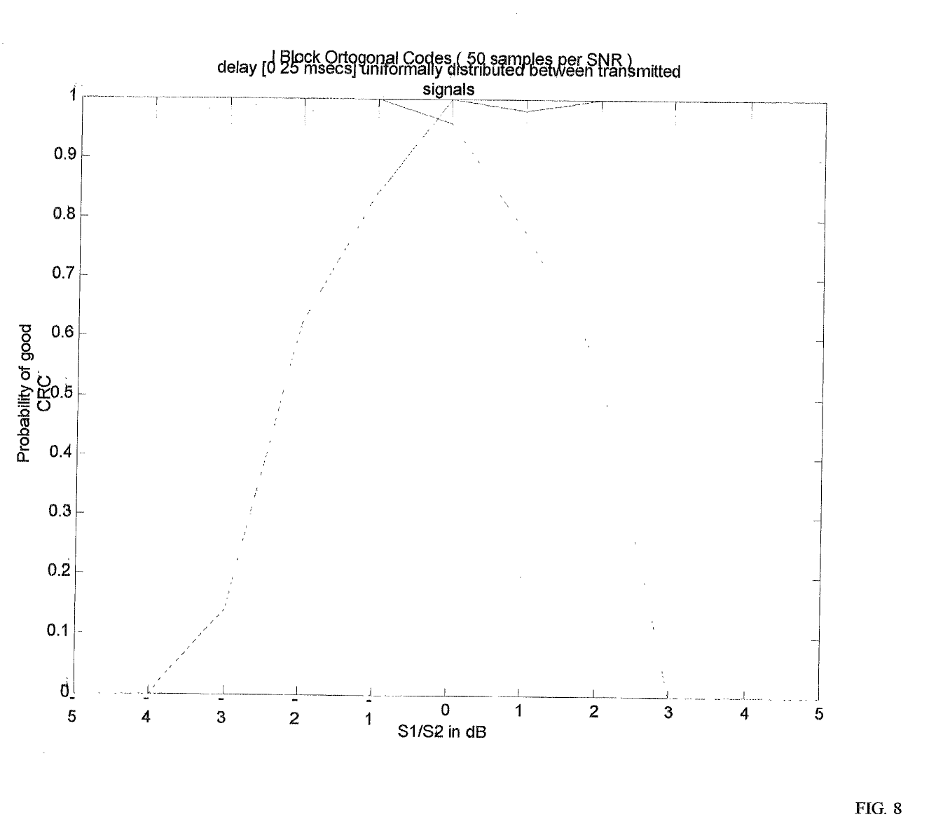

FIG. 8 illustrates a plot of the probability of good CRC versus the received signals. Two ITU's 15 are used to generate signals. One ITU 15 has the present low rate ITU codes, while the second ITU 15 uses quasi-orthogonal codes for the preamble and data scrambling. The audio output from two HF receivers is recorded using a sound card. Both signals are replayed and sent to the demodulator channel bank which has two orthogonal demodulator boards. The received signal level difference ranging from −5 db to +5 dB is sent to the two demodulator boards with a random delay between the two signals uniformly distributed from 0 to 25 milliseconds. Fifty sample runs are used for each signal level and the results are depicted in FIG. 8. It is clear from these results that either both signals are received at the same RBS 2 or one signal is received at one RBS 2 while the other signal is received at a different RBS 2 because of the distinct geographical location of ITU 15 and RBS 2.

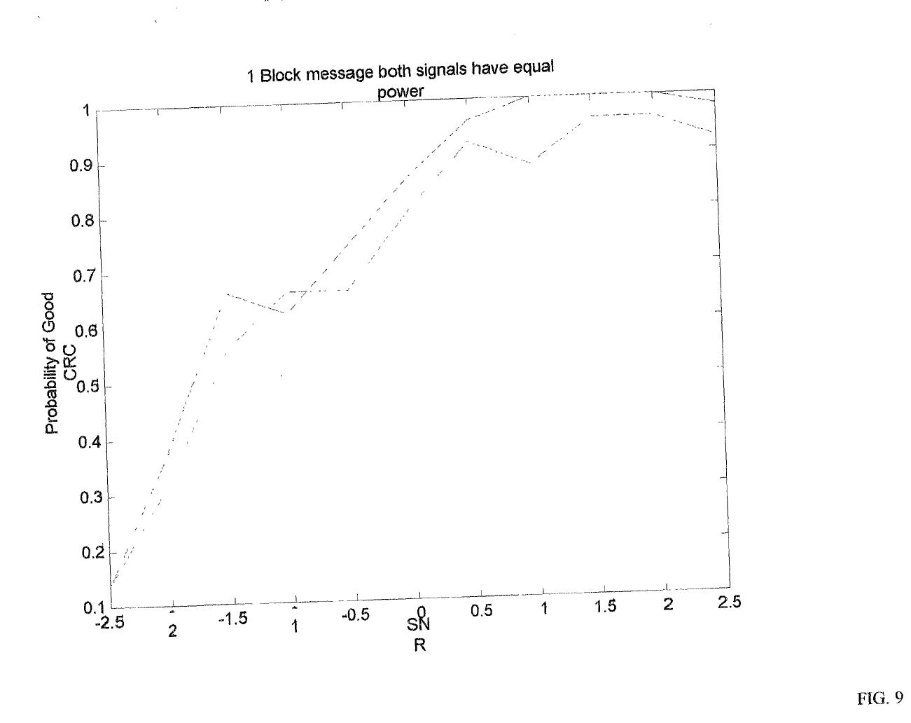

FIG. 9 illustrates the effects of signal to noise ratio on the system performance. Two ITUs 15 are used to generate signals. One ITU 15 has the present low rate ITU codes, while the second ITU 15 uses orthogonal codes for the preamble and data scrambling. One, two, three, four and five block messages are generated by both ITUs 15. The audio output from two HF receivers is recorded using a sound card. Both signals are replayed and sent to the demodulator channel bank that has two orthogonal demodulator boards. The received audio signals are set at equal power level. A gaussian noise source is computer generated and added to the audio signals. A pool of signals added to the noise signal is generated at different signal to noise ratio levels. This pool of signals uses different seeds for the random ensemble. This composite signal, audio from the first ITU, audio from the second ITU and noise, is sent to the two demodulator boards with a random delay between the two signals uniformly distributed from 0 to 25 milliseconds. Fifty sample runs are used for each signal to noise ratio value, and the results for one block message are depicted in FIG. 9. It is clear from these results that for all message lengths, either both signals are received at the same RBS 2 in the presence of noise, or one signal is received at one RBS 2 while the other signal is received at a different RBS 2 because of the distinct geographical location of ITU 15 and RBS 2.

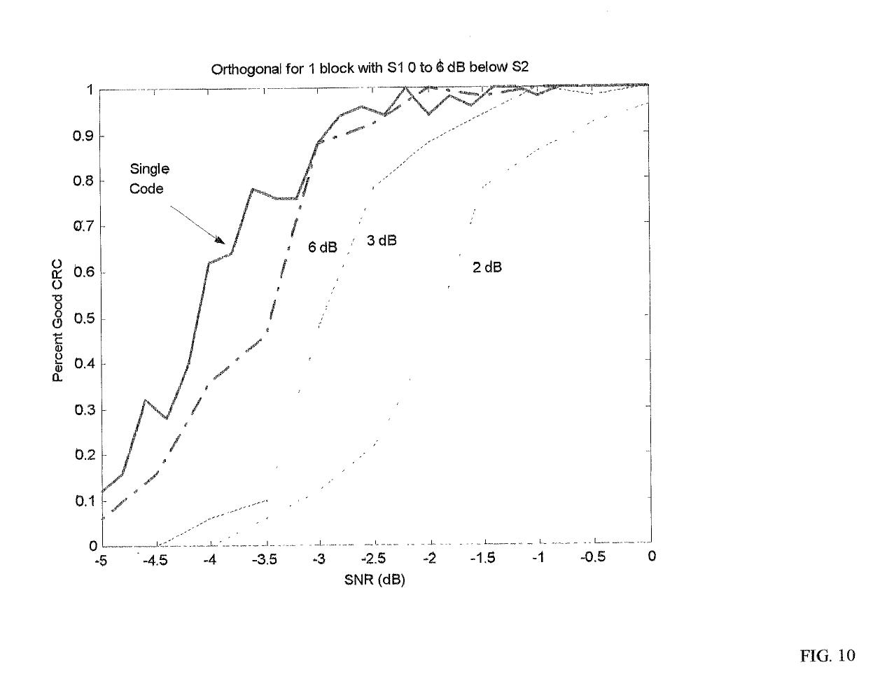

FIG. 10 illustrates the signal to noise ratio penalty for using two orthogonal code modems at the same time instead of a single modem transmission. Two HF ITUs 15 are used to generate signals. One ITU 15 has the present low rate ITU codes, while the second ITU 15 uses orthogonal codes for the preamble and data scrambling. One, two, three, four and five block messages are generated by both ITUs 15. The audio output from two TCI receivers is recorded using a sound card. Both signals are replayed and sent to the demodulator channel bank that has two orthogonal demodulator boards. The received audio signal level difference is varied from 2 to 6 dB. A gaussian noise source is computer generated and added to the audio signals. A pool of signals added to the noise signal is generated at different signal to noise ratio levels. This pool of signals uses different seeds for the random ensemble. This composite signal, audio from the first ITU 15, audio from the second ITU 15 and noise, is sent to the two demodulator boards with a random delay between the two signals uniformly distributed from 0 to 25 milliseconds. Fifty sample runs are used for each signal to noise ratio value, and the results are depicted, and the resulting MER curve for a one block message is shown in FIG. 10. The heavy curves annotated by single Code is the performance curve obtained when Orthogonal codes are not used.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for encoding signals in a Code Division Multiple Access communication system comprising:
(a) encoding a first communication signal with a first pseudorandom noise (PN) sequence;
(b) generating an exhaustive list of other PN sequences of the same length as the first PN sequence;
(c) selecting, from the exhaustive list, a subset of PN sequences that have a lowest possible cross correlation with the first PN sequence; and
(d) encoding a second communication signal using a selected one of the PN sequences from the subset having lowest possible cross correlation.

2. A method as in claim 1 wherein step (a) additionally comprises:
(i) Walsh encoding a first input signal;
(ii) modulating the Walsh encoded first input signal with the first PN sequence.

3. A method as in claim 1 wherein step (d) additionally comprises:
(iii) Walsh encoding a second input signal;
(iv) modulating the Walsh encoded second input signal with the selected one of the PN sequences from the subset.

4. A method as in claim 1 wherein step (b) additionally comprises:
(v) correlating the first communication signal with other PN signals encoded with selected one of the other PN sequences of the same length as the first PN sequence.

5. A method as in claim 1 wherein a bit order of the first communication signal and the second communication signal are scrambled.

6. A method as in claim 1 wherein the first communication signal and the second communication signal are modulated onto an identical radio frequency carrier signal.
